(19) United States
(12) Patent Application Publication
(10) Pub. No.: US 2021/0080031 A1
(43) Pub. Date: Mar. 18, 2021

(54) BUCKET MOUNTED HOSE SUPPORT

(71) Applicants: Anthony COLLETTI, Port Saint Lucie, FL (US); John Anthony DePaola, Jackson Township, NJ (US)

(72) Inventors: Anthony COLLETTI, Port Saint Lucie, FL (US); John Anthony DePaola, Jackson Township, NJ (US)

(21) Appl. No.: 17/022,995

(22) Filed: Sep. 16, 2020

Related U.S. Application Data
(60) Provisional application No. 62/901,673, filed on Sep. 17, 2019.

(51) Int. Cl. F16L 3/10; F16L 3/00

(52) U.S. Cl. CPC F16L 3/10; F16L 3/003

(57) ABSTRACT

A hose caddy employs a hose stand connected to a liquid receptacle. The hose stand is designed to hold a hose, a sponge and/or other cleaning items used in cleaning an object such as a car, off of the ground. This prevents the cleaning items from picking up debris. Since the hose stand holds the hose at a convenient height, the person cleaning the object is not required to constantly bend down to pick up the hose. The hose stand includes a shaft having an attachment structure at its lower end which is designed to clip to the wall of a bucket, preferably a standard 5-gallon paint bucket. A handle is connected to the upper end of the shaft with a cap creating at least at least one recess sized and shaped to hold one the hose, and at least one cleaning item.

### CROSS-REFERENCE TO A RELATED APPLICATION

This application claims priority to U.S. Provisional Patent Application Ser. No. 62/901,673 filed Sep. 17, 2019 titled “BUCKET MOUNTED GARDEN HOSE SUPPORT” by Anthony Colletti and John DePaola, and incorporates its disclosure as it were set forth in its entirely herein, to the extent that it does not conflict with the current disclosure.

### BACKGROUND OF THE INVENTION

### 1. Field of the Invention

The current invention relates to a device which holds a hose and cleaning items, to keep them clean and provides easy access to them during the cleaning process.

### 2. Description of Related Prior Art

The current invention related to the use of a hose, such as a garden hose, and other cleaning items used in cleaning an object. For simplicity, the current invention will be described in connection with washing a car, but it is understood that the current invention may be used in cleaning a variety of different items.

Many people derive great pleasure from a clean vehicle and spend the time and effort required to clean their vehicles. Often employed for this purpose are sponges, rags, hoses, and buckets, such as a conventional five (5) gallon paint bucket.

People typically clean cars in their driveways. Usually, there are no other structures in the driveway to place the cleaning items when not in use. These cleaning items are then commonly placed on the ground. It is known that placing these items, particularly sponges and rags, on the ground, they pick up unwanted debris. Sometimes the debris is made up of very small particles that are difficult to see. Even though the user does not see any debris, there are still small particles which cause small scratches to the car's finish, reducing the shine.

Also, since there are typically no other structures nearby to hold the hose, the hose is also placed on the ground. Debris is not such a problem with the hose; however, the person washing the car, (the “Washer”) has to constantly bend down to pick it up. This can become tiring.

Currently, there is a need for a device which keeps a hose and washing items clean and also keeps them within easy reach.

### BRIEF SUMMARY OF THE INVENTION

A hose stand 100 is disclosed that attaches to a liquid receptacle 10 to hold a hose 20 and cleaning items 17, 19 at a height to be easily reached by an average height person washing an object. The hose stand has an attachment structure such as a clamp 120 extending from a liquid receptacle, preferably a 5-gallon bucket 10, an elongated shaft 110 having an upper end 111 and a lower end 113 extending substantially vertically, the lower end 113 connected to the attachment structure 120, a support structure (handle) 130 connected to the upper end 111 of the shaft 110 with a connection device 150. The support structure has at least one recess 135 sized and shaped to hold one of the hose 20, and at least one cleaning item.

The current invention may also be described as a method of positioning a hose 20 used by a person in cleaning an object, and for holding cleaning items 17, 19 above the ground at a height that can be accessed by the person without bending down. This is done by creating a hose stand 1100, then securing the hose stand 1100 to a bucket 10.

The hose stand is created by providing a shaft 110 having a lower end 111 and an upper end 113, attaching an attachment structure 120 to the lower end 111 of shaft 110 that is capable of securely attaching to a liquid receptacle, attaching to the upper end 111 of shaft 110 to a support structure 130 having at least one recess 135 sized and shaped to hold a hose.

After the hose stand is constructed, then it is attached using an attachment structure 120, to the liquid receptacle (bucket) 10 to provide a hose stand 1100 for holding the hose and at least one cleaning item at a height that a standing average person can reach it without having to bend down.

### BRIEF DESCRIPTION OF THE DRAWINGS

The above-mentioned features and steps of the invention and the manner of attaining them will become apparent, and the invention itself will be best understood by reference to the following description of the embodiments of the invention in conjunction with the accompanying drawings, wherein like characters represent like parts throughout the several views and in which:

FIG. 1 is an overall view of one embodiment of a hose stand as it would appear in use, according to the current invention.

FIG. 2 is a front elevational view of the hose stand of FIG. 1.

FIG. 3 is a perspective, exploded view of the hose stand of FIG. 1.

FIG. 4 is an illustration of a configuration of the hose stand of FIG. 1 used for compact packing and shipping.

FIG. 5 is a perspective, exploded view of the hose stand of FIG. 1 showing suggested dimensions.

### DETAILED DESCRIPTION OF A PREFERRED EMBODIMENT OF THE INVENTION

Various embodiments of a bucket mounted hose support are disclosed and described in accordance with the present invention. In describing the embodiment as illustrated in the drawings, specific terminology will be used for the sake of clarity. However, the invention is not intended to be limited to the specific terms so selected, and it is to be understood that each specific term includes all technical equivalents that operate in a similar manner to accomplish a similar purpose.

As discussed above, there is a need for a device that can aid in keeping a hose, sponge, and other items off the ground and within easy reach during use. Embodiments of the present invention achieve this purpose by providing a clamp mounted support, the clamp adapted to secure the device on a bucket.

While most buckets are cylindrical or nearly cylindrical, they need not be so long as the bucket includes a wall to which a clamp can be secured. For purposes of this disclosure, the term “bucket” shall be used going forward.

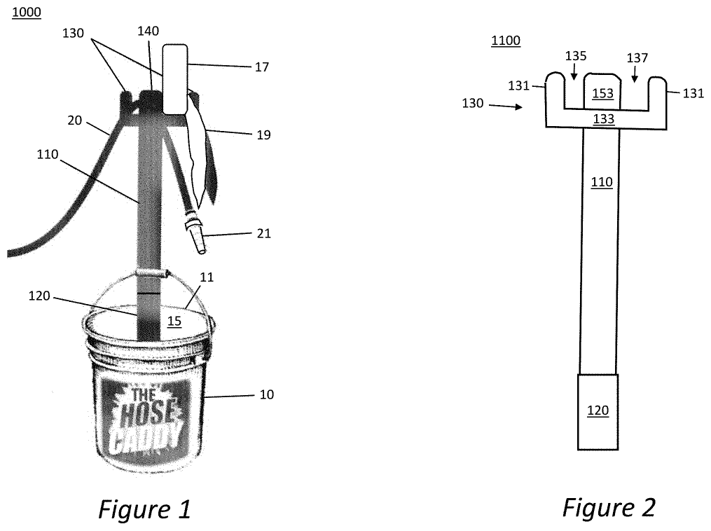

FIG. 1 is an overall view of one embodiment of a hose stand 1100 as it would appear in use, according to the current invention.

A bucket 10 used in the cleaning process contains water and/or cleaning solution to be used for cleaning an object, such as a car. Bucket 10 has an upper opening 15 which has a lip 11 encircling the upper opening 15.

Conventional 5-gallon paint buckets have approximately the same overall shape and lip shape. These can be considered a standard in the industry. Since these are inexpensive and very common, it is not uncommon to use this type of bucket 10.

The hose stand 1100 employs a shaft 110 intended to be held vertically by a clamp 120 at its lower end. The clamp 120 is designed to removably attach to the lip 11 of bucket 10, preferably a standard 5-gallon paint bucket described above. (The details of the clamp will be described in more detail with reference to other figures later.) Clamp 120 securely holds the hose shaft 110 in a substantially vertical position with a handle 130 and cap 140 attached to the top, as shown in FIG. 1.

A hose 20 used in the cleaning process is shown here draped over a horizontal support and between a vertical extension of a left side of a handle 130, and a cap 140 of the hose stand 100. This holds the hose 20 and its hose nozzle 21 at a convenient height in which the Washer can easily reach the hose 20 and nozzle 21 without having to bend down. The Washer may easily now grab the hose nozzle 21 and spray it onto the car to clean and rinse it or spray it into the bucket opening 15.

The Washer may also use a rag 19 or a sponge 17. Both the rag 19 and sponge 17 are shown sitting on a horizontal portion of handle 13 of the hose stand, to the right of cap 140. Now the rag 19 and sponge 17 are at a convenient height which allows washer to reach them without bending.

FIG. 2 is a front elevational view of the hose stand of FIG. 1.

Here the front of the clamp 120 is shown at the lower end of shaft 110. A handle 130 has a horizontal support 133 substantially perpendicular to the shaft 110. The horizontal support 133 have at least one vertical extension 131 extending upward from at least one side of the handle 130.

A cap 153 is secured to the handle 130 and shaft 140 between the vertical extensions thereby creating a left space 135 and a right space 137 between the cap 153 and the vertical extensions 131.

As seen in FIGS. 1 and 2, the left space 135 is designed to receive and hold hose 20 while the right space 137 is designed to hold the sponge 17, rag 19 (and possibly other cleaning items).

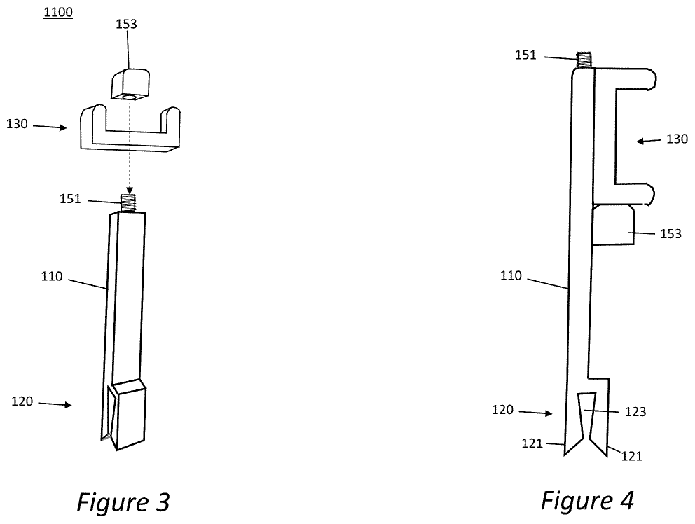

FIG. 3 is a perspective, exploded view of the hose stand of FIG. 1.

In this embodiment, the shaft 110 which has a threaded protrusion 150 extending upward form the upper end of the shaft 110. Handle 130 has a horizontal support 133 with central recess (not shown). The Handle 130 is placed on the shaft 110 such that the threaded protrusion 150 fits through the central recess. A threaded cap 140 screws onto the threaded protrusion 150 securing the handle 130 to top of shaft 110.

FIG. 4 is an illustration of a configuration used for compact packing and shipping of the hose stand.

As is shown, the support structure 130 and cap 153 may be pack alongside the shaft 110 as shown. This allows the hose stand 100 to be packed into a compact box having dimensions of 20″×4″×2″.

It will be appreciated that other securing configurations of the components are possible. For example, screw fittings to attach the handle 130 to the shaft 110 may be replaces with friction fit, quarter turn, or snap-on, or other known connections.

As shown in the figures, the handle is generally U-shaped such that it can support a hose, sponge, rag, and possibly other items. Various additional known configurations of the handles 130 are also possible, such as including additional “arms”, “clamps, and other conventional, known means for supporting or holding objects.

When the clamp 120 is secured on a bucket 10, the hose support 1100 will be held in a vertical position. For buckets 10 of suitable weight and configuration, this will be a stable condition. For other buckets the addition of water in the bucket will stabilize the device completely.

A particular package configuration is shown in FIG. 4. It has been found that fitting the handle and cap 153 alongside the shaft 110 provides for an efficient packaging solution.

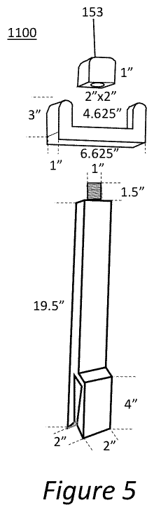

Sizes of the various components of the hose stand 1100 are shown in FIG. 5. These sizes are for the preferred embodiment and may be adapted or altered as might be appropriate.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined herein.

We claim:

1. A hose stand 1100 designed to attach to a liquid receptacle 10 and hold a hose 20 and cleaning items 17, 19 at a height to be easily reached by an average height person washing an object, comprising:
a. an attachment structure {clamp} 120 extending from the liquid receptacle 10;
b. an elongated shaft 110 having an upper end 111 and a lower end 113 extending substantially vertically, the lower end 113 connected to the attachment structure 120;
c. a support structure {handle} 130 connected to the upper end 111 of the shaft 110 with a connection device 150 {threaded protrusion 151 and threaded cap 153}, comprising:
i. at least one recess 135 sized and shaped to hold one of the hose 20, and at least one cleaning item.

2. The hose stand 1100 of claim 1 wherein the liquid receptacle 10 is a standard 5-gallon paint bucket.

3. The hose stand 1100 of claim 1, wherein the attachment structure 120 is a clamp designed to attach to a wall of the liquid receptacle.

4. The hose stand 1100 of claim 2, wherein the attachment structure 120 is a clamp sized and shaped to fit over a lip of the standard 5-gallon paint bucket and attach to the bucket's wall.

5. The hose stand 1100 of claim 1 wherein the shaft 110 is sized to hold support structure 130 at a height which an average human can reach without bending.

6. The hose stand 1100 of claim 1 wherein the attachment structure 120 has a vertical recess 123 adapted to receive and secure the sidewall of the liquid receptacle.

7. The hose stand 1100 of claim 6 wherein at least two prongs 121 define the recess 123.

8. The hose stand 1100 of claim 1 wherein the support structure 130 is a handle 130.

9. The hose stand 1100 of claim 8 wherein the handle 130 comprises:
a. a horizontal support 133 attached to the shaft 110; and
b. a first vertical extension 131 extending upward from a left side of the horizontal support 133 defining a first side of a first recess 135.

10. The hose stand of claim 9 wherein a cap 153 is attached to the horizontal support creating a second side of the first recess 135.

11. The hose stand of claim 9 wherein the handle 130 further comprises:
a second vertical extension 131 defining a first side of a second recess 137.

12. The hose stand of claim 11 wherein the cap 153 creates a second side of the second recess 135.

13. A method of positioning a hose used by a person in cleaning an object, and for holding cleaning items above the ground at a height that can be accessed by the person without bending down, comprising the steps of:
a. creating a hose stand 1100 comprising the steps of:
i. providing a shaft 110 having a lower end 111 and an upper end 113;
ii. attach an attachment structure 120 to the lower end 111 of shaft 110 that is capable of securely attaching to a liquid receptacle;
iii. attaching to the upper end 111 of shaft 110, a support structure 130 having at least one recess 135 sized and shaped to hold a hose;
b. attaching the attachment structure 120 to the liquid receptacle to provide a hose stand 100 for holding the hose {and at least one cleaning item} at a height that a standing average person can reach it without having to bend down.

14. The method of claim 13, wherein the shaft 110 has a length such that a person of average height could easily reach its upper end 111 when the shaft 110 is standing vertically.

15. The method of claim 13, wherein the liquid receptacle 10 is a standard 5-gallon paint bucket.

16. The method of claim 13, wherein the attachment structure 120 is a clamp designed to attach to a wall of the liquid receptacle.

17. The method of claim 15, wherein the attachment structure 120 is a clamp sized and shaped to fit over a lip of the standard 5-gallon paint bucket and attach to the bucket's wall.

18. The method of claim 13, wherein the shaft 110 is sized to hold support structure 130 at a height which an average human can reach without bending.

19. The method of claim 13, wherein the attachment structure 120 has a vertical recess 123 adapted to receive and secure the sidewall of the liquid receptacle.

20. A hose caddy 1000 that holds a hose 20 and cleaning items 17, 19 at a height to be easily reached by an average height person washing an object, comprising:
a. a liquid receptacle 10 capable of holding a cleaning solution;
b. an attachment structure 120 extending from the liquid receptacle 10;
c. an elongated shaft 110 having an upper end 111 and a lower end 113 extending substantially vertically, the lower end 113 connected to the attachment structure 120;
d. a support structure 130 connected to the upper end 111 of the shaft 110, comprising:
i. at least one recess 135 sized and shaped to hold one of the hose 20, and at least one cleaning item.
